(19) United States
(12) Patent Application Publication
(10) Pub. No.: US 2010/0315571 A1
(43) Pub. Date: Dec. 16, 2010

(54) Liquid Crystal Display Device

(76) Inventors: Chi-Ming Tseng, Taipei (TW); Huang-Jen Chen, Taipei (TW)

Correspondence Address: LIN & ASSOCIATES INTELLECTUAL PROPERTY, INC., P.O. BOX 2339, SARATOGA, CA, 95070-0339, US

(21) Appl. No.: 12/485,042

(22) Filed: Jun. 16, 2009

(51) Int. Cl. G02F 1/1333

(52) U.S. Cl. 349/59

(57) ABSTRACT

A liquid crystal display (LCD) device is connected with a printed circuit board (PCB) mounted to an electronic device. The LCD device includes a display module having a bare copper area, a holding frame for receiving the display module, and a shielding casing coupled to an end of the holding frame after the display module being assembled to the holding frame. The shielding casing has a bottom plate disposed between the display module and the PCB. The bottom plate has a portion contacting the bare copper area of the display module, and a contacting strip biased from the bottom plate and abutting against the PCB, for preventing the ESD from impacting the display module.

### BACKGROUND OF THE INVENTION

1. Field of the Invention

This present invention relates to a liquid crystal display (LCD) device, and more specifically to an LCD device with a protection structure against electrostatic discharge (ESD).

2. The Related Art

During the fabrication process of an LCD device, static electricity often develops, such as by friction, across various electrical components of the LCD device. Such static electricity may generate instant current that damages the electrical components of the LCD device. This may result in defects and malfunctions in the LCD device such as an electrical short circuit or electrical components damaging. In addition, in the process of using the LCD device, either touching an LCD panel by hands or outer environment variation, will generate a relatively high voltage in the LCD device, and may damage the electrical components in the LCD device. It is therefore desirable and important to release or eliminate the static electricity.

FIGS. 1-2 show a structure of an LCD device in prior art. The LCD device includes a frame member 10′ and a display module 20′ mounted in the frame member 10′. The frame member 10′ has a base 11′, a holding frame 12′ placed in the base 11′ for receiving the display module 20′, and a covering frame 13′ partially shielding the display module 20′ and combined with the base 11′. The base 11′ and the covering frame 13′ are made of metallic material for preventing the ESD from impacting the LCD device. Herein, the base 11′ is adhered with a Form-In-Place (FIP) 30′ for preventing the ESD from impacting the LCD device. However, the ESD-proof structure, including the base 11′, the covering frame 13′ and the FIP 30′, not only takes more time to manufacture and assembly, but also increases cost of the LCD device.

### SUMMARY OF THE INVENTION

An object of the invention is to provide an LCD device having a structure for preventing the ESD. The LCD device, which is connected with a printed circuit board (PCB) mounted to an electronic device, includes a display module having a bare copper area, a holding frame for receiving the display module, and a shielding casing coupled to an end of the holding frame after the display module being assembled to the holding frame. The shielding casing has a bottom plate disposed between the display module and the PCB. The bottom plate has a portion attached to the bare copper area of the display module, and a contacting strip biased from the bottom plate and abutting against the PCB, for preventing the ESD from impacting the display module.

As described above, the LCD device is provided with the shielding casing. The shielding casing is assembled to one end of the frame holding and capable of preventing the ESD resulted from the inner and outer of the display module from impacting the display module, by the bottom plate connecting with the display module and the PCB, thereby protecting the display module. Such structure is simple and easy to manufacture and assembly, furthermore, reduces the cost and volume of the LCD device.

### BRIEF DESCRIPTION OF THE DRAWINGS

The invention, together with its object and the advantages thereof may be best understood by reference to the following description taken in conjunction with the accompanying drawings, in which:

FIG. 1 is an assembled, perspective view of an LCD device in prior art;

FIG. 2 is an exploded, perspective view of the LCD device shown in FIG. 1;

FIG. 3 is an assembled, perspective view of an LCD device of an embodiment in accordance with the present invention;

FIG. 4 is an exploded, perspective view of the LCD device shown in FIG. 3;

FIG. 5 is a perspective view of a shielding casing of the LCD device shown in FIG. 4;

FIG. 6 is a perspective view of a holding frame of the LCD device shown in FIG. 4;

FIG. 7 is an assembled, perspective view of the LCD device shown in FIG. 3 viewed from a bottom angle;

FIG. 8 is a cross-sectional view showing the LCD device of FIG. 3 mounted into a mobile phone; and

FIG. 9 is a partly enlarged view showing an enlarged IX portion of FIG. 8.

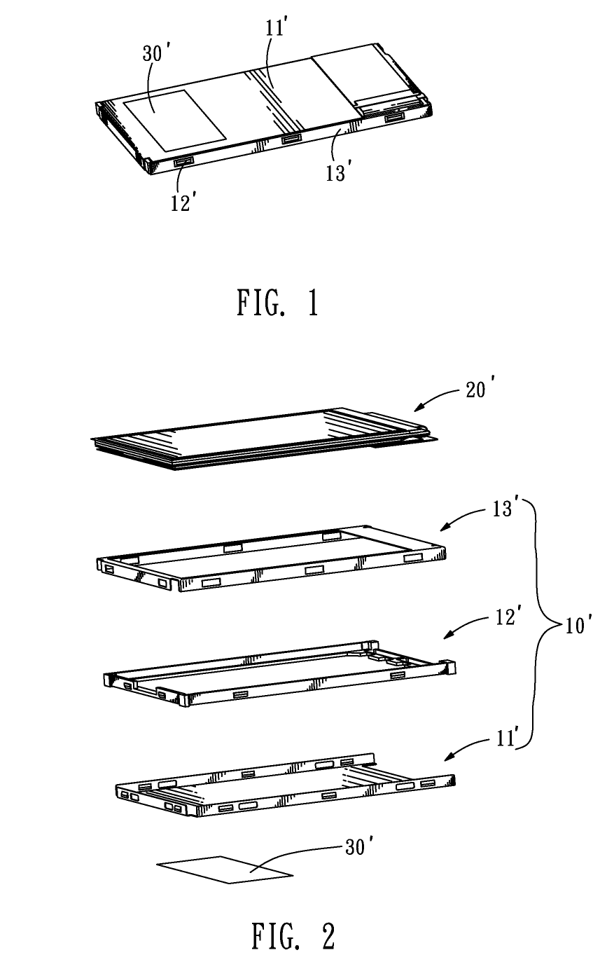

### DETAILED DESCRIPTION OF THE EMBODIMENT

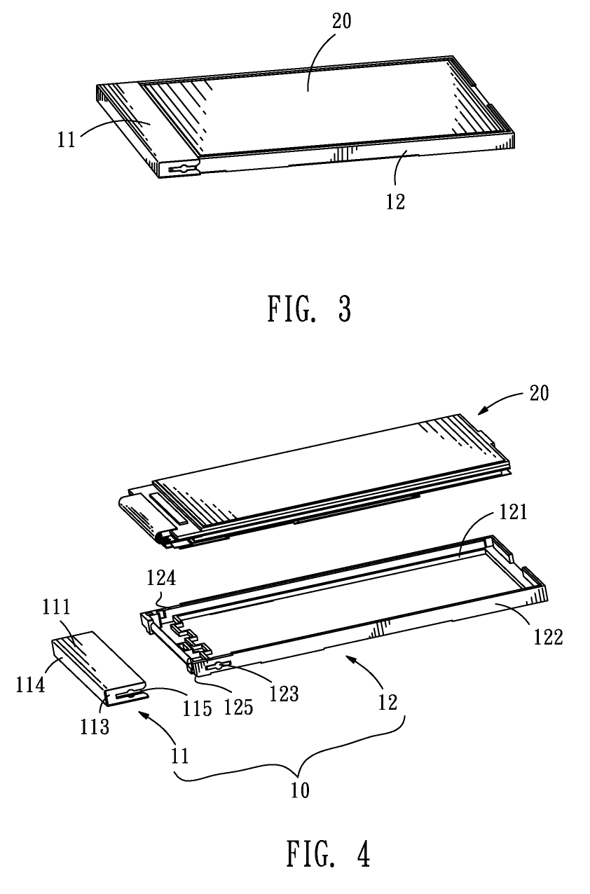

Referring to FIG. 3 and FIG. 4, an LCD device of the embodiment according to the present invention is shown. The LCD device includes a housing 10 and a display module 20 accommodated in the housing 10. The housing 10 has a rectangular holding frame 12 and a shielding casing 11 coupled to an end of the holding frame 12 after the display module 20 being received in the holding frame 12.

Please refer to FIG. 4 and FIG. 6, the holding frame 12 has a horizontal portion 121 and a vertical portion 122 extending upwards from an outer side of the horizontal portion 121, combined together to show an L shape. Each of the two opposite long vertical portions 122 has a protruding portion 123 at an end of an outer surface thereof, for buckling with the shielding casing 11. In this embodiment, the protruding portion 123 has a circular stopping lump 1232 and two leading laths 1231 extending along a longitudinal direction of the vertical portion 122 from two opposite sides of the stopping lump 1232. Top sides of the vertical portions 122 adjacent to the protruding portions 123 are formed with gaps 124, for engaging with the shielding casing 11. In this embodiment, two bottom corners of the vertical portions 122 adjacent to the respective protruding portions 123 have ramp surfaces 125 for guiding the shielding casing 11 coupled to the holding frame 12 smoothly.

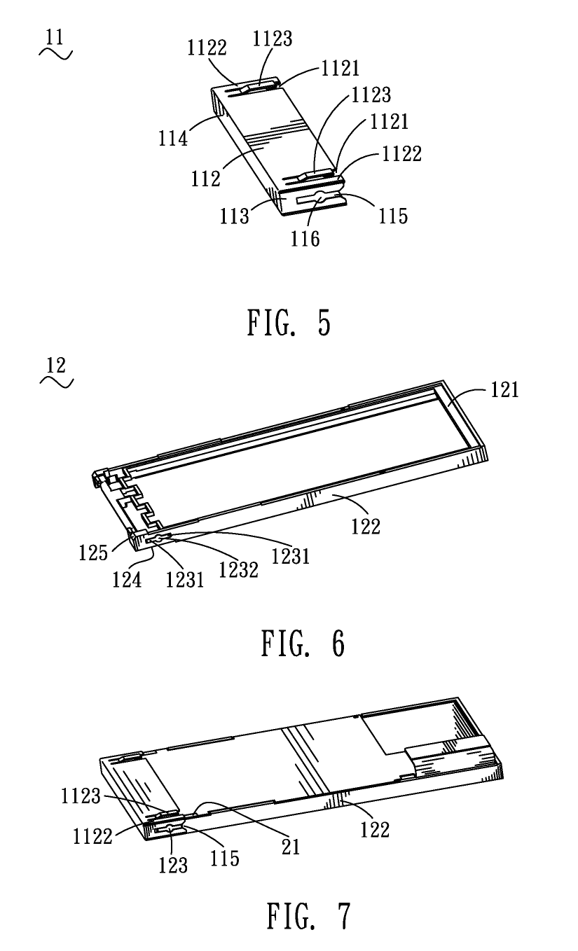

Please refer to FIG. 4 and FIG. 5, the shielding casing 11 has a rectangular covering plate 114. The covering plate 114 has edges extended perpendicular to the covering plate 114 to form a top plate 111, a bottom plate 112 facing the top plate 111 and two opposite lateral plates 113 respectively connecting with the top plate 111 and the bottom plate 112. The bottom plate 112 may be punched to form two recesses 1121 at two opposite ends thereof, with a first contacting strip 1122 formed between the recess 1121 and the corresponding lateral plate 113 for touching a bare copper area 21 of the display module 20 (see FIG. 7). The recesses 1121 extends perpendicular to the covering plate 114 and have edges adjacent to the covering plate 114 bent outwards and extended parallel to and opposite to the covering plate 114 to form second contacting strips 1123, for resting against a printed circuit board (PCB) 30 (see FIG. 9). In this embodiment, the first and second contacting strips 1122 and 1123 have free ends bent inwards in an overlapping manner. Each of the lateral plates 113 has an open slot 115 extending perpendicular to the covering plate 114, corresponding to the leading laths 1231. Middles of two opposite sides of the slot 115 are formed with notches 116, corresponding to the stopping lump 1232.

It should be noted that the shape of the protruding portion of the holding frame can be changed for conforming to different demands and should not be limited. For example, the protruding portion can be shaped to show a coattail lump or a wedged lump. Accordingly, the lateral plate is formed with a coattail recess corresponding to the coattail lump or an opening corresponding to the wedged lump, for fixing the shielding casing to the holding frame.

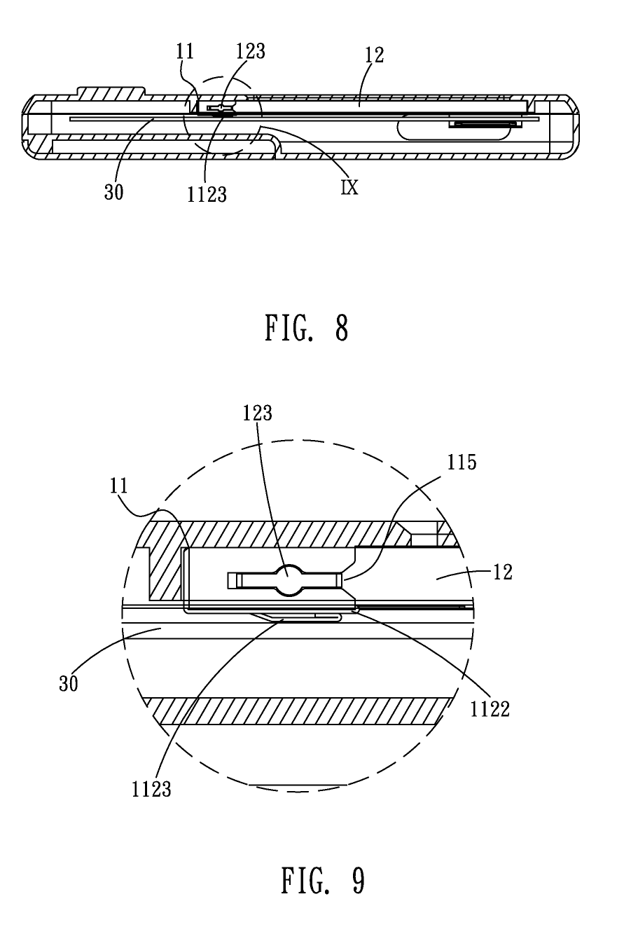

Please refer to FIGS. 7-9, in assembly, the display module 20 is held by the holding frame 12. The shielding casing 11 is coupled with the holding frame 12 by the leading laths 1231 and the stopping lump 1232 respectively received in the slot 115 and the notches 116. Herein, the top plate 111 is located in the gaps 124 so that the top plate 111 is substantially flush with a top surface of the display module 20. The first contacting strips 1122 touch the bare copper areas 21 of the display module 20. Supposing that the LCD device is mounted to a mobile phone, the second contacting strips 1123 abut against the PCB 30 of the mobile phone. Thus the static electricity resulted from the inner and outer of the display module 20 can be discharged, thereby preventing the ESD from damaging inner electrical components of the display module 20.

As described above, the LCD device is provided with the shielding casing 11. The shielding casing 11 wraps one end of the frame holding 12 and is capable of discharging the static electricity from the inner and outer of the display module 20, by the first and second contacting strips 1122 and 1123 respectively connecting with the display module 20 and the PCB 30, protecting the display module 20. Such structure is simple and easy to manufacture and assembly, furthermore, reduces the cost and volume of the LCD device.

The foregoing description of the present invention has been presented for purposes of illustration and description. It is not intended to be exhaustive or to limit the invention to the precise form disclosed, and obviously many modifications and variations are possible in light of the above teaching. Such modifications and variations that may be apparent to those skilled in the art are intended to be included within the scope of this invention as defined by the accompanying claims.

What is claimed is:

1. A liquid crystal display (LCD) device connected with a printed circuit board (PCB) mounted in an electronic device, comprising:
a display module having a bare copper area;
a holding frame for receiving the display module; and
a shielding casing coupled to an end of the holding frame after the display module being assembled to the holding frame, the shielding casing having a bottom plate disposed between the display module and the PCB, the bottom plate having a portion contacting the bare copper area of the display module, and a contacting strip biased from the bottom plate and abutting against the PCB.

2. The LCD device as set forth in claim 1, wherein the shielding casing has two lateral plates perpendicularly connecting with the bottom plate, the bottom plate has two recesses at two opposite ends thereof, a portion between the recess and the corresponding lateral plate is defined with a first contacting strip attached to the bare copper area of the display module, the contacting strip, which is a second contacting strip, is bent downwards and extended parallel to the bottom plate from an edge of the recess.

3. The LCD device as set forth in claim 2, wherein the first and second contacting strips have free ends bent upwards in an overlapping manner.

4. The LCD device as set forth in claim 1, wherein the shielding casing has a covering plate, edges of the covering plate are extended perpendicular to the covering plate to form a top plate, the bottom plate facing the top plate and two lateral plates connecting with the top plate and the bottom plate.

5. The LCD device as set forth in claim 4, wherein the holding frame is rectangular and has two protruding portions at two opposite outer sides thereof, each of the protruding portions has a circular stopping lump and two leading laths extending opposite to each other from two sides of the stopping lump along a sliding direction of the shielding casing, each of the lateral plates has an open slot for receiving the leading laths and two notches formed at two opposite sides of the slot for buckling with the stopping lump.

6. The LCD device as set forth in claim 4, wherein the holding frame is formed with gaps at top sides thereof, the top plate of the shielding casing is engaged in the gaps for making the top plate flush with a top of the display module.
